(19) United States
(12) Patent Application Publication
(10) Pub. No.: US 2006/0124440 A1
(43) Pub. Date: Jun. 15, 2006

(54) Method and apparatus to produce potable water

(76) Inventors: Richard S. Pautz, San Antonio, TX (US); Patricia T. Graef, Fort Myers, FL (US); Larry J. Klekar, Garden Ridge, TX (US); Danny Dotson, Adkins, TX (US)

Correspondence Address: FITZPATRICK CELLA HARPER & SCINTO, 30 ROCKEFELLER PLAZA, NEW YORK, NY, 10112, US

(21) Appl. No.: 11/011,872

(22) Filed: Dec. 13, 2004

(51) Int. Cl. C02F 1/04; B01D 3/14

(52) U.S. Cl. 203/10; 203/DIG. 4; 203/49; 203/87; 202/200; 202/186

(57) ABSTRACT

A method and apparatus for producing potable water from non-potable water, in which a supply of air is passed through a heating unit to increase the air temperature and then passed through an evaporative cooling media through which the non-potable water is passed in liquid/gas contact with the heated air. The temperature of the air leaving the evaporative media is reduced as a result of contact with the water, and its moisture content is increased. The cooler moist air is then passed through a cooling coil to cause the moisture in the air to condense as liquid water, which is then collected and made suitable for use as drinking water.

### FIELD OF THE INVENTION

The present invention relates to a method and apparatus for producing potable water from non-potable water while treating air to provide conditioned air to an enclosure. Non-potable water is defined as water from a source that is not drinkable, such as, but not limited to, an ocean or sea (salty or brackish), a lake, a natural or man-made reservoir, a stream or river, etc.

### BACKGROUND OF THE INVENTION

A variety of different technologies have been developed over the years to produce drinking water from non-potable water. These technologies often involve the consumption of substantial amounts of power and are relatively expensive. In addition, demand for this technology is often located in very hot and humid areas of the world, and particularly in isolated locations which also require air treatment for the purpose of providing conditioned air to living spaces. That need creates additional power consumption requirements, which increases the total cost of any such installation.

### OBJECTS OF THE INVENTION

It is an object of the present invention to provide a new and improved method and apparatus for producing potable water from non-potable water, while at the same time producing conditioned air for supply to enclosures.

Yet another object of the present invention is to provide an improved method and apparatus for producing potable water from non-potable water, which overcomes the disadvantages of prior art desalinization arrangements.

A still further object of the present invention is to provide a combined non-potable water purification system and air conditioning system with reduced power requirements.

### SUMMARY OF THE INVENTION

In accordance with an aspect of the present invention, a method and apparatus for producing potable water from non-potable water and for also producing conditioned air is provided in which a supply of ambient atmospheric air, or other air, is passed through a heating device in order to increase its temperature to improve the rate of evaporation of water exposed to that air. The heated air is passed through an evaporative cooling media to which non-potable water is supplied for flow in liquid gas contact with the heated air. As the heated air passes through the evaporative media in contact with the non-potable water, the water evaporates entering the air and the air temperature is reduced while its moisture content is increased. The thus cooled and moistened air then flows through a cooling unit which causes the water moisture in the air to condense as liquid water. That water is collected, treated and optionally irradiated by UV light and or ozonator in order to render it drinkable.

In accordance with another aspect of the present invention, the heating and cooling devices used in the process consist of the heating and cooling coils of a refrigerant based air conditioning unit.

In accordance with a still further aspect of the invention, a desiccant wheel is positioned downstream of the cooling coil to further dry the cooled air leaving the coil. This dried and cooled air can then be supplied to an enclosure for air conditioning purposes.

In an alternative arrangement, a further cooling coil can be positioned downstream of the first coil, in lieu of the desiccant wheel, to provide further cooling and drying of the air for air conditioning purposes.

In yet another alternative arrangement, the condenser coil may be positioned downstream of the first coil, in lieu of the desiccant wheel, to provide even greater performance of the system in a water making only mode.

### BRIEF DESCRIPTION OF THE DRAWINGS

The above, and other objects, features and advantages of this invention will be apparent in the following detailed description of illustrative embodiments thereof, which is to be read in connection with the accompanying drawings, wherein:

FIG. 1 is a schematic diagram of the water purification and air conditioning system of the present invention;

FIG. 2 is an illustration similar to FIG. 1 of another embodiment of the invention;

FIG. 3 is a schematic illustration of a third embodiment of the invention suitable for use in remote ocean locations, such as oil well platforms; and

FIG. 4 is a psychometric diagram of the process performed by the apparatus shown in FIG. 3.

### DETAILED DESCRIPTION OF PREFERRED EMBODIMENTS

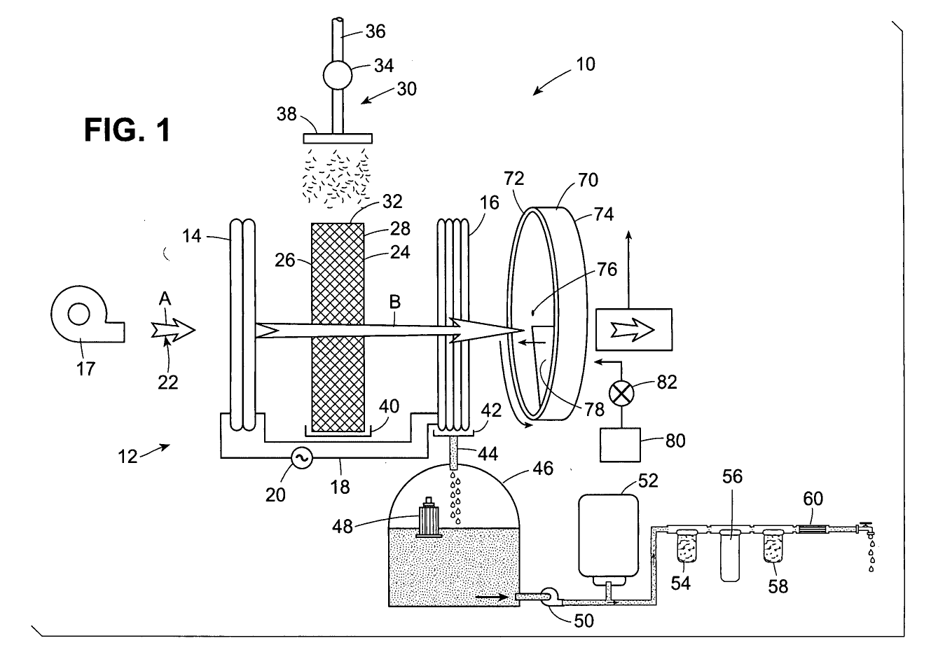

Referring now to the drawings in detail, and initially to FIG. 1 thereof, a non-potable water treatment and air conditioning plant 10, constructed in accordance with the present invention, is illustrated. The system of FIG. 1 includes a refrigeration cycle unit 12, which includes a heating coil 14, a cooling coil 16, a refrigerant supply line 18, and a compressor 20. The refrigeration unit operates in a known manner such that coil 16 absorbs heat from air passing through it to produce cooled and dried air, while heating coil 14 discharges heat from the refrigerant in line 18, which was collected in the coil 16, to the air passing through it.

In the embodiment of the present invention, a supply of outside air is caused to flow through the refrigeration unit, as indicated schematically by the arrows A and B, under the influence of a fan or blower 17 first through the heating coil 14, and thence through the cooling coil 16. However, in accordance with a feature of the present invention, an evaporative cooling pad 24 of known construction is positioned between the two coils. This evaporative cooling pad is preferably formed from multiple layers of corrugated sheet material, with the corrugations preferably being cross-fluted in order to produce a plurality of passageways through the device located at angles to the vertical or horizontal directions. Such corrugated fill material is well-known in evaporative cooling arts, and is manufactured by the assignee of this application, Munters Corporation.

The passageways of the corrugated panels are opened towards the faces 26, 28 of the evaporative media to receive the air flow from the heating coil 14 and discharge it to the cooling coil 16.

A water supply system 30 is also provided for supplying water to the top surface 32 of the evaporative pad. The water supply system includes a pump 34, which through piping 36 can draw non-potable water to a water distribution pan or spray head 38 immediately above the evaporative pad in a conventional manner such as is used with evaporative coolers. The non-potable water preferably is sprayed across the top of the evaporative pad and then flows through the passageways of the pad toward the bottom of the pad.

The air which flows through the heating coil 14 is heated during its passage through the coil, removing heat from the refrigerant. Heating of the air increases its ability to cause evaporation of moisture when in contact with water.

As this heated air passes through the passageways of the evaporative media, the water flowing on the surfaces of the corrugated sheets in the pad evaporates, thereby reducing the temperature of the air leaving the pad while increasing its moisture content.

A large amount of water is supplied to the evaporator pad to keep the pad clean and free from buildup of salts and minerals. A collection gutter 40 is provided at the bottom of the pad to collect the remaining water and return it to the non-potable water source.

As the air flowing from the evaporative cooling pad to the cooling coil 16 passes through the coil, the cold coil causes the moisture in the air to condense on the coil and drip to the bottom of the coil, where it is collected in a water collection trough 42 which supplies the collected water through a pipe 44 to a storage tank 46. The air leaving the coil 16 is now drier than the air that entered the coil and cooler than the air when it left the evaporative pad. That air is now available for use as conditioned air, e.g. as supply return or make up air, for a building or other enclosure.

The water collected in storage tank 46 is pure water, with the salt or other dissolved solids removed. This water would be potable but, as a precaution the water may be further treated in order to assure its safety for drinking. Thus, if desired, a conventional ozonator 48 can be mounted in the storage tank for adding oxygen and ozone to the water. The water is collected through a pump 50 under the influence of a pressure tank 52 in a known manner, and supplied to a pair of filters 54 (preferably a 5 micron filter) and 56 (preferably a 1 micron filter) and thence to a conventional T & O filter 58. Finally, the water can be exposed, through transparent piping, to ultraviolet light from a surrounding set of ultraviolet light bulbs 60 to kill any bacteria remaining in the water.

As a result, a simple system is provided for not only demineralizing water, but cooling make up air for use in air conditioning systems. Although the invention contemplates producing potable water for human consumption, the use of the potable water produced by the invention is not limited to drinking but may be used for other purposes as well, e.g. as a process liquid.

In the embodiment of FIG. 1, an additional air drying unit may also be provided to further improve the condition of air being supplied to the enclosures and the cooling coil. In particular, a conventional desiccant wheel 70 of known construction may be provided downstream of cooling coil 16. This wheel is formed of corrugated material which creates a series of passages through the wheel from one face 72 to the other 74. The wheel surfaces defining the passageways are coated with a desiccant material so that as the air from coil 16 passes through the wheel the desiccant materials absorb moisture in the air, thus further drying the air before it is supplied to the enclosure.

As is known in conventional desiccant wheel devices, wheel 70 rotates about its central axis 76 to continuously bring the surfaces of the wheel past a regeneration zone 78, which is defined in the wheel by duct work (not shown) on opposite sides of the wheel. In the regeneration zone, heated air supplied from a heating device 80 of known construction (which may, for example, be a heating coil containing waste heat through which air is circulated by a fan 82). The heated air passes from the heating device 80 through the duct work through the regeneration zone 78 and removes the moisture from the desiccant material.

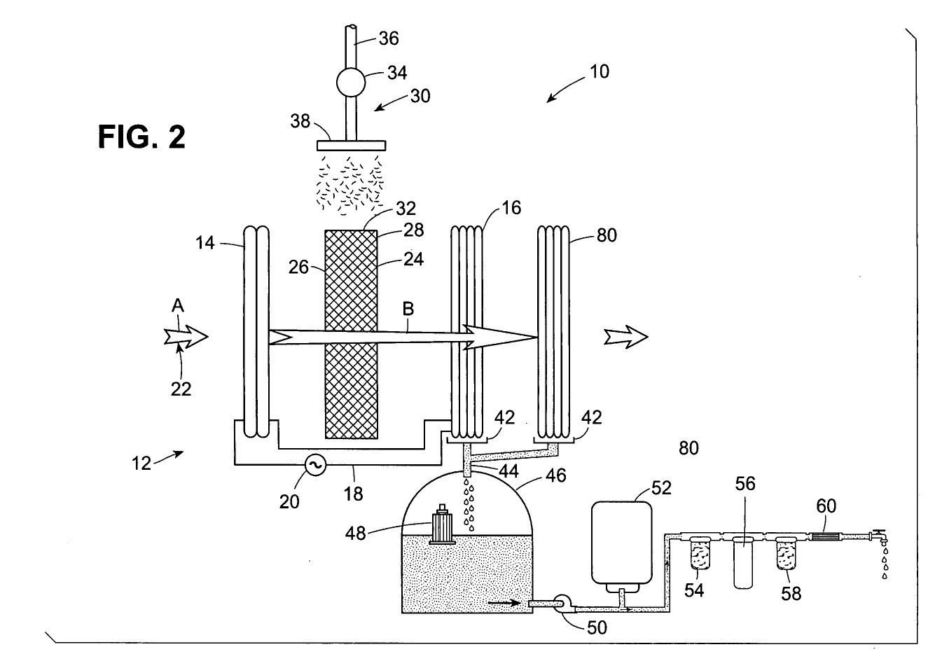

FIG. 2 illustrates another embodiment of the present invention, wherein like numerals represent like parts. In this embodiment, in lieu of the desiccant wheel 70, a second cooling coil 80 is provided downstream of cooling coil 16. This cooling coil can be connected either in the same refrigerant circuit as coil 16, or in a separate refrigerant circuit. The use of the second cooling coil 80 provides additional cooling and drying to the air stream as necessary. The water collected on the second cooling coil can also be supplied to the tank 46 if desired, or it can simply be discharged.

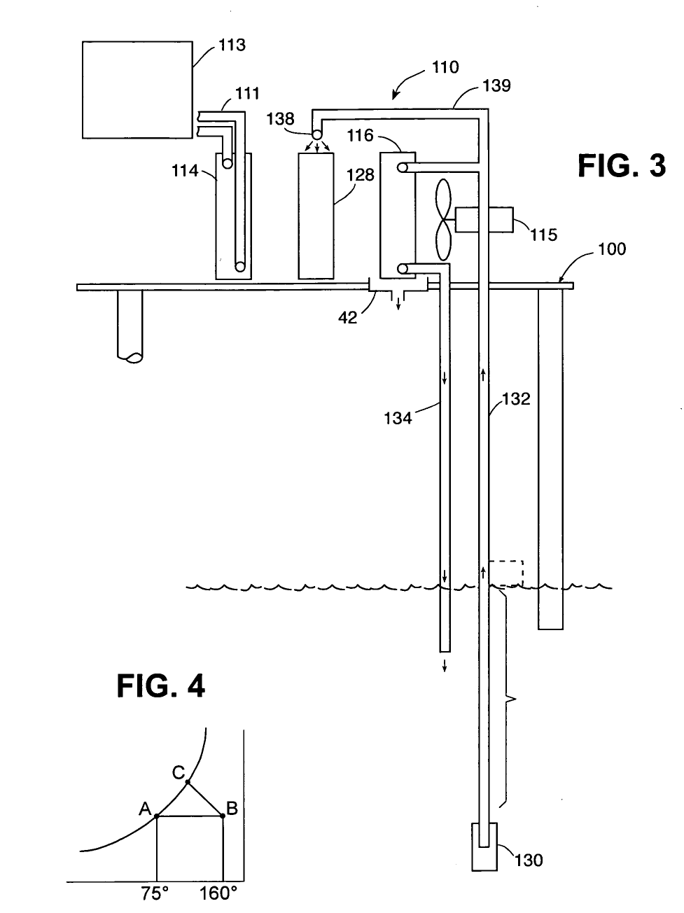

FIG. 3 illustrates a third embodiment of the invention, particularly useful on ocean platforms, such as oil drilling rigs or any other application where a non-potable water source and waste heat are available. In this embodiment, as an example, an oil platform 100 is schematically illustrated on which the water treatment and air conditioning unit 110 is mounted. The system 110 includes a heating coil 114, a cooling coil 116, and an evaporative pad 128 positioned between the two coils. The coil 114 is connected by a piping system 111 to a source of waste heat 113. This source of waste heat can be any known source available, for example, on an oil drilling platform, such as, for example, exhaust from electrical generating units which can be used to heat water flowing in the coils 114.

The cooling coil 116 is arranged to receive and discharge sea water or other non-potable water in a circuit with the ocean or other non-potable water source. In the ocean example, a submerged pump 130 is provided, which draws water from the ocean at depths where the ocean temperature is at most 75° F., and supplies the cool water through a vertical pipeline 132 to the coil 116. The cooling water passes through the coil and is discharged through another pipeline 34 returning it to the ocean. As an alternative to a deep water submersible pump, a centrifugal pump at the ocean surface may be used.

Atmospheric air is drawn through the system by the fan 115. The air first enters the heating coil 114, is warmed by the waste heat, and is supplied then to the evaporative pad 128. As previously described, the pad is supplied with non-potable water on its upper surface in a spray or drip pattern in a known manner through a discharge head 138 from a supply line 139 which also receives the water from the supply line 132. The heated air leaving the heating coil enters the evaporative pad and is cooled by evaporation of the water in the pad and absorbs moisture and humidity until it exits the pad. The now cooled and moist air enters the cooling coil where it is cooled and dried as the moisture in the air condenses on the coil 116 and is collected in the receptacle 42 for use as potable water, as described above.

In the illustrative embodiment of FIG. 3, as shown in the psychometric diagram of FIG. 4, the air entering the heating coil 114 at point A has a temperature of 75° F. and a 74° F. wet bulb temperature. After passing through heating coil 114, the air temperature rises to 160° F. at point B, but its humidity content remains the same. After passing through the evaporative pad, the temperature of the air is decreased to 94° F., but its moisture content increases to point C. This cooled and moist air is then further cooled in the cooling coil 116 to a temperature of 85° F. or less, and a lower moisture content.

Under these conditions, and using a pumping system in which 3 gallons per minute of non-potable water are applied to the evaporative pad, approximately 25 gallons per hour of fresh water can be recovered. In addition, cooled, dried air is available for air conditioning the enclosures of the oil platform.

Accordingly, a very simple and economical unit is provided which can perform two important functions in remote hot locations, i.e., the creation of potable water and the production of air conditioned air suitable for supply to enclosures.

Although illustrative embodiments of the invention have been described herein with reference to the accompanying drawings, it is to be understood that various changes and modifications may be effected therein by those skilled in the art, without departing from the scope or spirit of this invention.

What is claimed is:

1. A method of producing potable water from non-potable water comprising the steps of:
I) providing a supply of air;
ii) passing said supply of air through a heating device to increase its temperature;
iii) passing the heated air leaving the heating device through an evaporative cooling media;
iv) supplying non-potable water to the evaporative cooling media whereby the non-potable water passes in liquid gas contact with the heated air and the temperature of the air is reduced while its moisture content is increased;
v) passing the thus cooled and moistened air through a cooling coil to cause water moisture in the air to condense as liquid water; and
vi) collecting said liquid water.

2. The method as defined in claim 1 including the step of passing the cooled and dried air leaving the coiling coil through a desiccant unit to filter the dry air.

3. The method as defined in claim 2 including the step of supplying the cooled and further dried air from the desiccant unit to an enclosure as conditioned air.

4. The method as defined in claim 1 including the step of heating said liquid water.

5. The method as defined in claim 4 wherein said heating step includes the steps of filtering the liquid water and subjecting it to UV light.

6. The method as defined in claim 1 including the step of passing the cooled and dried air leaving the cooling coils through a second cooling coil to further cool said air.

7. The method as defined in claim 1 including the step of supplying said cooling coils with non-potable water whose temperature is less than the temperature of the air leaving the evaporative pad.

8. Apparatus for producing potable water from non-potable water comprising means for heating a supply of air to increase its temperature; an evaporative media; means for supplying non-potable water to said evaporative media for passage therethrough in liquid/gas contact with air heated in said heating means thereby to reduce the temperature of the heated air while increasing its moisture content; means for cooling the air leaving the evaporative media to cause water moisture in the air to condense as liquid water; and means for causing said supply of air to move first through the heating means, then through the evaporative media and then through said cooling means.

9. Apparatus as defined in claim 8 including means for collecting water condensed in said cooling means.

10. Apparatus as defined in claim 8 including desiccant means for drying air leaving said cooling means; said means for causing said supply of air to move also causing said air to flow from the cooling means to and through the desiccant means.

11. Apparatus defined in claim 8 wherein said heating means comprises a heating coil and said apparatus includes means for heating the heating coil.

12. Apparatus as defined in claim 8 wherein said cooling means comprises a cooling coil and said apparatus includes means for cooling the cooling coil.

13. Apparatus as defined in claim 12 wherein said means for cooling the cooling coil comprises means for supplying non-potable water to the coil at a temperature less than that of the moist warm air leaving the evaporative pad.

14. Apparatus as defined in claim 8 including an air conditioning system which comprises a refrigerant heating coil that comprises said heating means, a refrigerant cooling coil that comprises said cooling means and a compressor for moving refrigerant between said coils.

15. Apparatus as defined in claim 10 wherein said desiccant means comprises a rotary desiccant wheel.

16. Apparatus as defined in claim 15 including means for regenerating said desiccant wheel.

17. Apparatus as defined in claim 8 including means for treating said liquid water to improve its potability.

18. The method as defined in claim 17 wherein said heating means includes a water filter and a UV light source.

19. Apparatus as defined in claim 8 including a second cooling means downstream from the first mentioned cooling means for further cooling said air.

20. Apparatus as defined in claim 13 wherein said cooling means comprises a cooling coil and said apparatus includes means for cooling the cooling coil.

21. Apparatus as defined in claim 20 wherein said means for cooling the cooling coil comprises means for supplying non-potable water to the coil at a temperature less than that of the moist warm air leaving the evaporative pad.

22. Apparatus as defined in claim 21 wherein said means for heating the heating coil comprises means for supplying waste hot water to the heating coil.
